(19) United States
(12) Patent Application Publication
(10) Pub. No.: US 2011/0286598 A1
(43) Pub. Date: Nov. 24, 2011

(54) INFORMATION PROCESSING APPARATUS, METHOD, AND PROGRAM

(75) Inventors: Susumu Honda, Kanagawa (JP); Tomohiko Nagayama, Tokyo (JP); Yuji Hiura, Kanagawa (JP)

(73) Assignee: SONY CORPORATION, Tokyo (JP)

(21) Appl. No.: 13/107,138

(22) Filed: May 13, 2011

(30) Foreign Application Priority Data
May 21, 2010 (JP) P2010-117007

(51) Int. Cl. H04L 9/00

(52) U.S. Cl. 380/277

(57) ABSTRACT

An information processing apparatus includes a key retaining section retaining a key for use in writing data in a data storage area of another information processing apparatus or reading data stored in the data storage area, and a storage section that stores data. The information processing apparatus is used by being combined with the other information processing apparatus. The key retained in the key retaining section is protected with a key retained in the other information processing apparatus. The storage section is protected with the key retained in the other information processing apparatus.

### BACKGROUND OF THE INVENTION

1. Field of the Invention

The present invention relates to an information processing apparatus, method, and program and, in particular, an information processing apparatus, method, and program capable of enriching services provided through an IC card for non-contact communications.

2. Description of the Related Art

IC cards for non-contact communications have been available. These IC cards have functions, for example, a function as a commuter pass for riding a vehicle and a function as a credit card. An IC card is advantageously excellent in portability, but is easily lost and stolen. Japanese Unexamined Patent Application Publication No. 2002-175512 presents a suggestion for easily reissuing an IC card when lost or stolen, in which IC cards are used in a pair.

Japanese Unexamined Patent Application Publication No. 2002-175512 describes that two IC cards are used in a pair. An IC card A has a memory in which an ID number of the card A, which is its own ID number, is written and has a paired-card discrimination memory area in which an ID number of its counterpart IC card B is written at a predetermined address. The IC card B has a memory in which an ID number of the card B, which is its own ID number, is written and has a paired-card discrimination memory area in which an ID number of its counterpart IC card A is written at a predetermined address. Therefore, only by checking these ID numbers in a crossing manner, the two IC cards can be easily confirmed as paired cards.

### SUMMARY OF THE INVENTION

In Japanese Unexamined Patent Application Publication No. 2002-175512, although the functions of the two IC cards are used, the technology is only for the purpose of simple copying. Thus, to provide a function to an IC card or delete a function or data therefrom for enrichment of services to be provided with the IC card, a dedicated reader/writer is used, which is not disclosed in Japanese Unexamined Patent Application Publication No. 2002-175512.

However, enrichment of services to be provided by using an IC card and further improvement in usability are desired.

It is desirable to allow enrichment of services using an IC card and further improvement of usability.

An information processing apparatus according to a first embodiment of the present invention includes key retaining means for retaining a key for use in writing data in a data storage area of another information processing apparatus or reading data stored in the data storage area, and storage means for storing data. The information processing apparatus is used by being combined with the other information processing apparatus, the key retained in the key retaining means is protected with a key retained in the other information processing apparatus, and the storage means is protected with the key retained in the other information processing apparatus.

The other information processing apparatus is an IC card, and the information processing apparatus can be combined with the other information processing apparatus by being affixed to the IC card.

In the information processing apparatus according to the first embodiment of the present invention, a key for use in writing data in a data storage area of another information processing apparatus or reading data stored in the data storage area is retained. Also, the key that is used in combination with the other information processing apparatus and retained is protected with a key retained in the other information processing apparatus, and the stored data is protected with the key retained in the other information processing apparatus.

An information processing apparatus according to a second embodiment of the present invention includes storage means for storing data, second key retaining means for retaining a second key for use by the information processing apparatus in writing data in the storage means or reading the data stored in the storage means, the second key for use in reading a first key retained in another information processing apparatus, and third key retaining means for retaining a third key for use by the information processing apparatus in writing data in a data storage area of the other information processing apparatus or reading data stored in the data storage area.

The information processing apparatus is an IC card, and can be used with the other information processing apparatus affixed thereto.

In the information processing apparatus according to the second embodiment of the present invention, data is stored, a second key for use by the information processing apparatus in writing data or reading the stored data and for use in reading a first key retained in another information processing apparatus is retained, and a third key for use by the information processing apparatus in writing data in a data storage area of the other information processing apparatus or reading data stored in the data storage area is retained.

According to a third embodiment of the present invention, an information processing apparatus retaining a first key and a second key includes first storage means for storing first data, retaining means for retaining a fourth key reading the first key and the second key from the information processing apparatus when another information processing apparatus retaining a third key and including second storage means for storing second data is combined, first reading means for reading the first and second keys from the information processing apparatus with the fourth key, second reading means for reading the third key retained in the other information processing apparatus with the first key read by the first reading means, first processing means for accessing the first storage means included in the information processing apparatus by using the third key read by the second reading means and writing data in the first storage means or reading the first data stored in the first storage means, and second processing means for accessing the second storage means included in the other information processing apparatus by using the second key read by the first reading means and writing data in the second storage means or reading the second data stored in the second storage means.

The information processing apparatus and the other information processing apparatus can communicate with each other in a non-contact manner.

The information processing apparatus is an IC card, and the other information processing apparatus is affixed to the IC card.

The information processing apparatus can retain a fifth key for use in accessing the first storage means of the information processing apparatus to read the data stored in the first storage means when the other information processing apparatus is not combined with the information processing apparatus.

An information processing method according to a fourth embodiment of the present invention for an information processing apparatus retaining a first key and a second key and including first storage means for storing first data and at least retaining means for retaining a fourth key reading the first key and the second key from the information processing apparatus when the information processing apparatus is combined with another information processing apparatus retaining a third key and including second storage means for storing second data includes the steps of reading the first key and the second key from the information processing apparatus by using the fourth key, reading the third key retained in the other information processing apparatus with the read first key, accessing the first storage means included in the information processing apparatus by using the read third key, and writing data in the first storage means or reading the first data stored in the first storage means, and accessing the second storage means included in the other information processing apparatus by using the read second key, and writing data in the second storage means or reading the second data stored in the second storage means.

A computer-readable program according to a fifth embodiment of the present invention causes an information processing apparatus retaining a first key and a second key and including first storage means for storing first data and at least retaining means for retaining a fourth key reading the first key and the second key from the information processing apparatus when the information processing apparatus is combined with another information processing apparatus retaining a third key and including second storage means for storing second data, to execute a process including the steps of reading the first key and the second key from the information processing apparatus by using the fourth key, reading the third key retained in the other information processing apparatus with the read first key, accessing the first storage means included in the information processing apparatus by using the read third key, and writing data in the first storage means or reading the first data stored in the first storage means, and accessing the second storage means included in the other information processing apparatus by using the read second key, and writing data in the second storage means or reading the second data stored in the second storage means.

In the information processing apparatus, information processing method, and program according to the third, fourth, and fifth embodiments of the present invention, when another information processing apparatus retaining a third key and including second storage means for storing second data is combined with the information processing apparatus retaining a first key and a second key and including first storage means for storing first data, a fourth key reading the first key and the second key from the information processing apparatus is retained, the first key and the second key are read from the information processing apparatus by using the fourth key, the third key retained in the other information processing apparatus is read with the read first key, the first storage means included in the information processing apparatus is accessed by using the read third key and data is written in the first storage means or the first data stored in the first storage means is read, and the second storage means included in the other information processing apparatus is accessed by using the read second key and data is written in the second storage means or the second data stored in the second storage means is read.

An information processing apparatus according to a sixth embodiment of the present invention includes storage means for storing data. The information processing apparatus is used in combination with another information processing apparatus, and the storage means is protected with a key retained in the other information processing apparatus.

The other information processing apparatus is an IC card, and the information processing apparatus can be combined with the other information processing apparatus by being affixed to the IC card.

In the information processing apparatus according to the sixth embodiment of the present invention, data is stored, the information processing apparatus is used in combination with the other information processing apparatus, and the stored data is protected with a key retained in the other information processing apparatus.

An information processing apparatus according to a seventh embodiment of the present invention includes a data storage area that stores data, key retaining means for retaining a key for use by another information processing apparatus in writing data in the data storage area or reading the data stored in the data storage area when the other information processing apparatus is combined with the information processing apparatus, and storage means for storing data. The key retaining means retains a plurality of keys, and the plurality of keys are each for accessing the data storage area included in each of a plurality of the information processing apparatuses.

An IC card can be combined with the information processing apparatus affixed thereto.

In the information processing apparatus according to the seventh embodiment of the present invention, when the other information processing apparatus is combined with the information processing apparatus including a data storage area that stores data, a plurality of keys for use by the other information processing apparatus in writing data in the data storage area or reading the data stored in the data storage area are retained, and the plurality of keys are each for accessing the data storage area included in each of a plurality of the information processing apparatuses.

An information processing apparatus according to an eighth embodiment of the present invention retains a first key and includes first storage means for storing first data, retaining means for retaining a second key reading the first key from the information processing apparatus when another information processing apparatus including second storage means for storing second data is combined, first reading means for reading the first key from the information processing apparatus by using the second key, and processing means for accessing the second storage means included in the other information processing apparatus by using the first key read by the first reading means and writing data in the second storage means or reading the second data stored in the second storage means.

The information processing apparatus and the other information processing apparatus can communicate with each other in a non-contact manner.

The information processing apparatus is an IC card, and the other information processing apparatus can be kept affixed to the IC card.

The information processing apparatus can further retain a third key for use in accessing the first storage means of the information processing apparatus and reading the data stored in the first storage means or writing data in the first storage means.

An information processing method according to a ninth embodiment of the present invention for an information processing apparatus retaining a first key and including first storage means for storing first data and at least retaining means for retaining a second key reading the first key from the information processing apparatus when another information processing apparatus including second storage means for storing second data is combined, includes the steps of reading the first key from the information processing apparatus by using the second key, and accessing the second storage means included in the other information processing apparatus by using the read first key and writing data in the second storage means or reading the second data stored in the second storage means.

A computer-readable program according to a tenth embodiment of the present invention that causes an information processing apparatus retaining a first key and including first storage means for storing first data and at least retaining means for retaining a second key reading the first key from the information processing apparatus when another information processing apparatus including second storage means for storing second data is combined, to execute a process including the steps of reading the first key from the information processing apparatus by using the second key and accessing the second storage means included in the other information processing apparatus by using the read first key and writing data in the second storage means or reading the second data stored in the second storage means.

In the information processing apparatus, method, and program according to eighth, ninth, and tenth embodiments of the present invention, a second key is retained for reading the first key from the information processing apparatus when another information processing apparatus including second storage means for storing second data is combined with the information processing apparatus retaining a first key and including first storage means for storing first data, the first key is read from the information processing apparatus by using the second key, and, by using the read first key, the second storage means included in the other information processing apparatus is accessed, and data is written in the second storage means or the data stored in the second storage means is read.

According to the embodiments of the present invention, functions can be easily added to an IC card.

According to the embodiments of the present invention, services provided by the IC card can be enriched. Also, usability of the IC card can be improved.

### BRIEF DESCRIPTION OF THE DRAWINGS

FIG. 1 is a diagram of the structure of a system to which an embodiment of the present invention is applied;

FIG. 2 is a diagram of the structure of a reader/writer;

FIG. 3 is a flowchart for describing a process by the reader/writer;

FIG. 4 is a flowchart for describing a process regarding issuance of a membership card;

FIG. 5 is a flowchart for describing a process regarding issuance of an electronic contract;

FIG. 6 is a diagram of the structure of a system to which another embodiment of the present invention is applied;

FIG. 7 is a flowchart for describing a process regarding issuance of a loyalty card; and

FIG. 8 is a diagram for describing a recording medium.

### DESCRIPTION OF THE PREFERRED EMBODIMENTS

With reference to the drawings, embodiments of the present invention are described in detail below.

### Structure of the IC Card

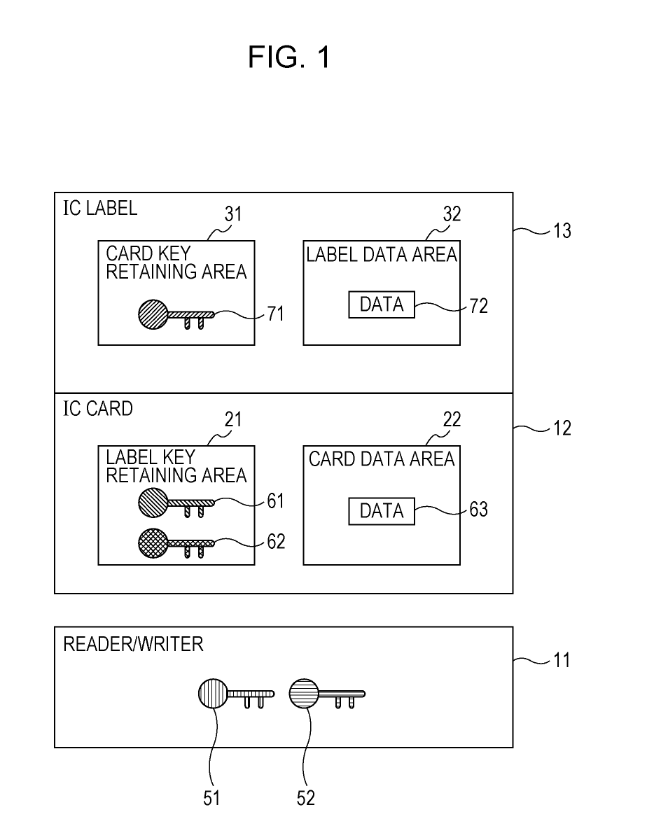

FIG. 1 is a diagram of the structure of a system to which an embodiment of the present invention is applied. A system depicted in FIG. 1 includes a reader/writer 11, an IC card 12, and an IC label 13. The reader/writer 11 and the IC card 12 communicate with each other in a non-contact manner. Furthermore, the reader/writer 11 and the IC label 13 also communicate with each other in a non-contact manner.

The IC label 13 is configured to be affixed to the IC card 12. Affixation not only means that the IC label 13 is pasted to the IC card 12 as a label but also means that the IC label 13 has a shape similar to that of the IC card 12 and is stacked on the IC card 12 for use. That is, in applying an embodiment of the present invention, pasting may not necessarily be a condition.

Also, in another embodiment, the IC label 13 may not be an adhesive label but may be fastened to the IC card 12 with a clip or the like. In this manner, an embodiment of the present invention can be applied as long as the IC card 12 and the IC label 13 are held over the reader/writer 11 at the same time and the reader/writer 11 is configured to be able to communicate with the held IC card 12 and the IC label 13 each other. Here, it is assumed, as an exemplary embodiment for description, that the IC label 13 is an adhesive label and is affixed to the IC card 12 for use.

The IC card 12 includes a label key retaining area 21 and a card data area 22. The IC label 13 includes a card key retaining area 31 and a label data area 32. In these areas, keys and data are stored (managed). Keys are used for authentication in reading data written in the card data area 22 and the label data area 32 and writing data therein. These keys are now described.

The reader/writer 11 retains two keys. One of the two keys retained in the reader/writer 11 is a key for use in reading a key and data retained in the IC label 13 when the IC label 13 is affixed to the IC card 12. This key is a label key retaining area key 51 for reading keys retained in the label key retaining area 21 of the IC card 12.

This label key retaining area key 51 is a key common to services, and is a read-only key. In other words, the label key retaining area key 51 is used to read keys from the IC card 12, and is not a key for use in writing keys and data.

The other one of the keys retained in the reader/writer 11 is a card data area key 52 for use in reading data (data 63) retained in the card data area 22 of the IC card 12 when the IC label 13 is not affixed to the IC card 12. This card data area key 52 is a key common to services, and is a read-only key.

Writing in the card data area 22 is enabled only when the IC label 13 is affixed, and writing in the IC card 12 is not allowed only with the keys included in the reader/writer 11. Therefore, the card data area key 52 is a read-only key.

In this manner, the keys included in the reader/writer 11 are those for reading keys and data from the IC card 12, and are not those for writing keys and data in the IC card 12 and the IC label 13.

In the label key retaining area 21 of the IC card 12, a card key retaining area key 61 for reading a key (a card data area key 71) retained in the card key retaining area 31 of the IC label 13 and a label data area key 62 for reading data (data 72) retained in the label data area 32 of the IC label 13. In the card data area 22 of the IC card 12, data 63 is retained.

The card key retaining area key 61 is a key unique to the IC label 13, and is a read-only key. That is, the card key retaining area key 61 is a key for reading the key (the card data area key 71) retained in the IC label 13, but is not a key for writing a key and data in the IC label 13.

The label data area key 62 is a key unique to the IC label 13, and is a read-write key. That is, the label data area key 62 is a key for use in reading the data (the data 72) stored in the label data area 32 of the IC label 13 and also in writing data in the label data area 32.

In the card key retaining area 31 of the IC label 13, the card data area key 71 for use in reading the data 63 retained in the card data area 22 of the IC card 12 or writing the data 63 is retained. The card data area key 71 is a key unique to the IC card 12, and a read write key. In the label data area 32 of the IC label 13, the data 72 is retained.

The IC card 12 is configured so as to be unable to obtain the card key retaining area 31 and write data in the card data area 22 of the IC card 12 when the IC label 13 is not affixed to the IC card 12.

The card key retaining area key 61 and the label data area key 62 retained in the label key retaining area 21 of the IC card 12 are each unique to the IC label 13. Therefore, if an IC label 13′ (a dash is added for discrimination from the IC label 13; the same goes below) different from the IC label 13 is affixed to the IC card 12, keys to be retained in the label key retaining area 21 are a card key retaining area key 61′ and a label data area key 62′ corresponding to the IC label 13′.

The card key retaining area key 61, the label data area key 62, and the card data area key 71 retained in the IC card 12 and the IC label 13 are keys unique to the IC card 12 and the IC label 13 in a pair. The label key retaining area key 51 and the card data area key 52 retained in the reader/writer 11 are keys unique to each service unit, and can be used in any pair of the IC card 12 and the IC label 13.

The service unit means each of various services, which will be described further below, that can be provided with a pair of the IC card 12 and the IC label 13. Therefore, different label key retaining area key 51 and card data area key 52 are used for each service. In other words, a different label key retaining area key 51 and a different card data area key 52 are retained for each reader/writer 11 supporting a service.

The card key retaining area key 61 and the label data area key 62 retained in the label key retaining area 21 of the IC card 12 are protected with the label key retaining area key 51 retained in the reader/writer 11. Also, the card data area 22 of the IC card 12 is configured to be unable to be accessed without the card data area key 52 retained in the reader/writer 11 or the card data area key 71 retained in the IC label 13.

The card data area key 71 retained in the card key retaining area 31 of the IC label 13 is protected with the card key retaining area key 61 retained in the IC card 12. Also, the label data area 32 of the IC label 13 is configured to be unable to be accessed without the label data area key 62 retained in the IC card 12.

### Structure of the Reader/Writer

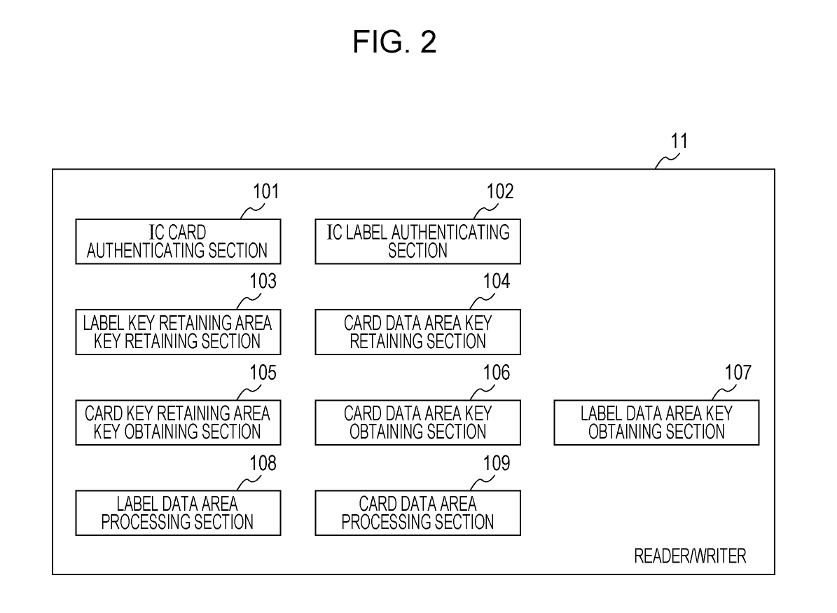

Next, the structure of the reader/writer 11 is described with reference to FIG. 2. The structure of the reader/writer 11 depicted in FIG. 2 covers a portion for authentication and data writing with the IC card 12 and the IC label 13, which will be described below. The reader/writer 11 is configured to also include a communicating section not shown or the like.

The reader/writer 11 mainly includes process functions of performing authentication, retaining keys, obtaining keys, and reading and writing data. The reader/writer 11 includes an IC card authenticating section 101, an IC label authenticating section 102, a label key retaining area key retaining section 103, a card data area key retaining section 104, a card key retaining area key obtaining section 105, a card data area key obtaining section 106, a label data area key obtaining section 107, a label data area processing section 108, and a card data area processing section 109.

The IC card authenticating section 101 performs authentication of the IC card 12. The IC label authenticating section 102 performs authentication of the IC label 13. The label key retaining area key retaining section 103 retains the label key retaining area key 51. The card data area key retaining section 104 retains the card data area key 52.

The card key retaining area key obtaining section 105 obtains the card key retaining area key 61 retained in the label key retaining area 21 of the IC card 12. The card data area key obtaining section 106 obtains the card data area key 52 retained in the card data area key retaining section 104 or the card data area key 71 retained in the card key retaining area 31 of the IC label 13. The label data area key obtaining section 107 obtains the label data area key 62 retained in the label key retaining area 21 of the IC card 12.

The label data area processing section 108 writes data in the label data area 32 of the IC label 13 and reads data from the label data area 32. The card data area processing section 109 writes data in the card data area 22 of the IC card 12 and reads data from the card data area 22.

### Operation of the Reader/Writer

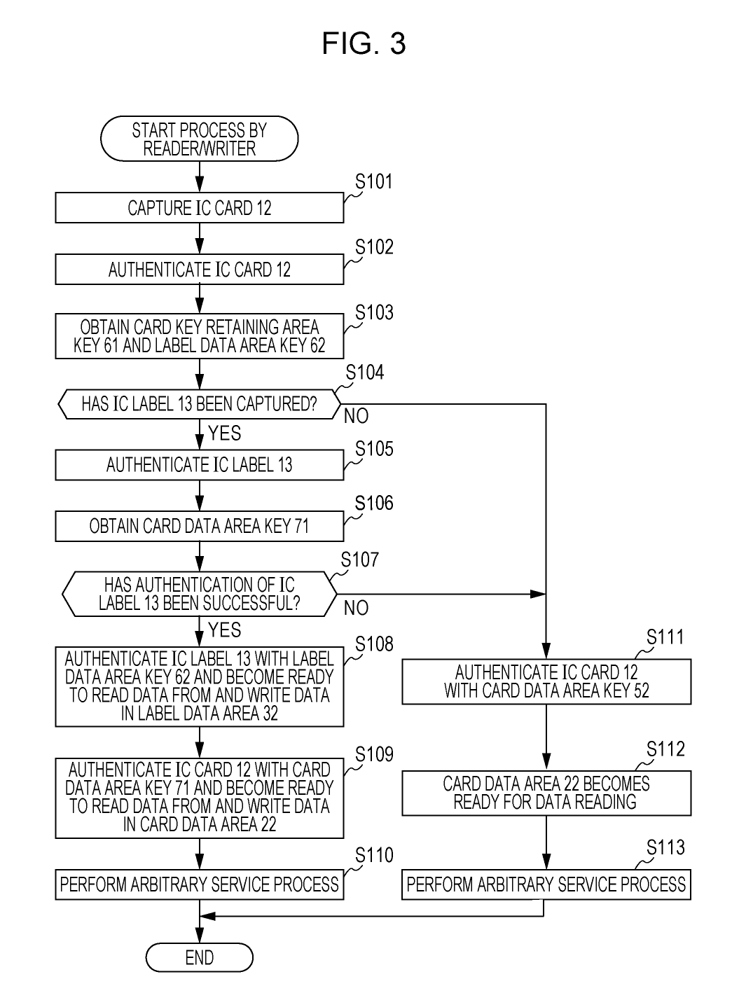

The process to be performed by the above-structured reader/writer 11 is described with reference to a flowchart of FIG. 3. At step S101, the reader/writer 11 captures the IC card 12. For example, when the IC card 12 is held by a user over the reader/writer 11, the reader/writer 11 is assumed to be able to capture the IC card 12. Also, the reader/writer 11 is configured to monitor by polling whether the IC card 12 is held over and to capture the IC card 12 when held.

At step S101, when the IC card 12 is captured, the procedure goes to step S102, where authentication of the IC card 12 is performed. The IC card authenticating section 101 (FIG. 2) reads the label key retaining area key 51 retained in the label key retaining area key retaining section 103, and performs authentication of the IC card 12 by using this label key retaining area key 51.

With authentication, the reader/writer 11 can access the label key retaining area 21 of the IC card 12. If authentication is not successful, it is determined that an IC card not allowed to be handled by the reader/writer 11 has been captured, and the procedure onward is not performed.

At step S103, the card key retaining area key obtaining section 105 reads and retains the card key retaining area key 61 from the label key retaining area 21 of the IC card 12 allowed to be accessed. The label data area key obtaining section 107 reads and retains the label data area key 62 from the label key retaining area 21 of the IC card 12.

At step S104, it is determined whether the IC label 13 has been captured. When the IC label 13 is affixed to the IC card 12, the IC label 13 is captured. If the IC label 13 is not affixed, the IC label 13 is not captured. When it is determined at step S104 that the IC label 13 has been captured, the procedure goes to step S105.

At step S105, authentication of the IC label 13 is performed. When it is determined that the IC label 13 has been captured, the IC label authenticating section 102 performs authentication of the IC label 13 by using the card key retaining area key 61 obtained and retained by the card key retaining area key obtaining section 105. With authentication, the reader/writer 11 can access the card key retaining area 31 of the IC label 13.

At step S106, the card data area key obtaining section 106 reads and retains the card data area key 71 from the card key retaining area 31 of the IC label 13 allowed to be accessed. Then, at step S107, it is determined whether authentication of the IC label 13 has been successful. It is determined that authentication of the IC label 13 has failed when the card key retaining area 31 has been tried to be accessed by using the card key retaining area key 61 but the card key retaining area 31 is not allowed to be accessed due to a wrong card key retaining area key 61 and thus the card data area key 71 is not obtained.

As described above, the IC card 12 and the IC label are used in a pair. If this pair is not a correct combination, the card data area key 71 is not obtained, and therefore authentication fails. A specific example will be described further below. By way of example, when the IC label 13 is resold, the IC card 12 and the IC label 13 do not form a correct set on a buyer's side, and therefore are not allowed to be used after resale. Thus, such resale can be prevented.

Here, for convenience of description, it is assumed that authentication of the IC label 13 has been successful. When it is determined that authentication of the IC label 13 has been successful at step S107, the procedure goes to step S108.

In the processes up to step S107, the reader/writer 11 obtains and retains the card key retaining area key 61, the label data area key 62, and the card data area key 71. At step S108, the label data area processing section 108 performs authentication of the label data area 32 of the IC label 13 by using the retained label data area key 62, and becomes ready to write data in and read data from the label data area 32.

At step S109, the card data area processing section 109 performs authentication of the card data area 22 of the IC card 12 by using the retained card data area key 71 obtained from the IC label 13, and becomes ready to write data in and read data from the card data area 22.

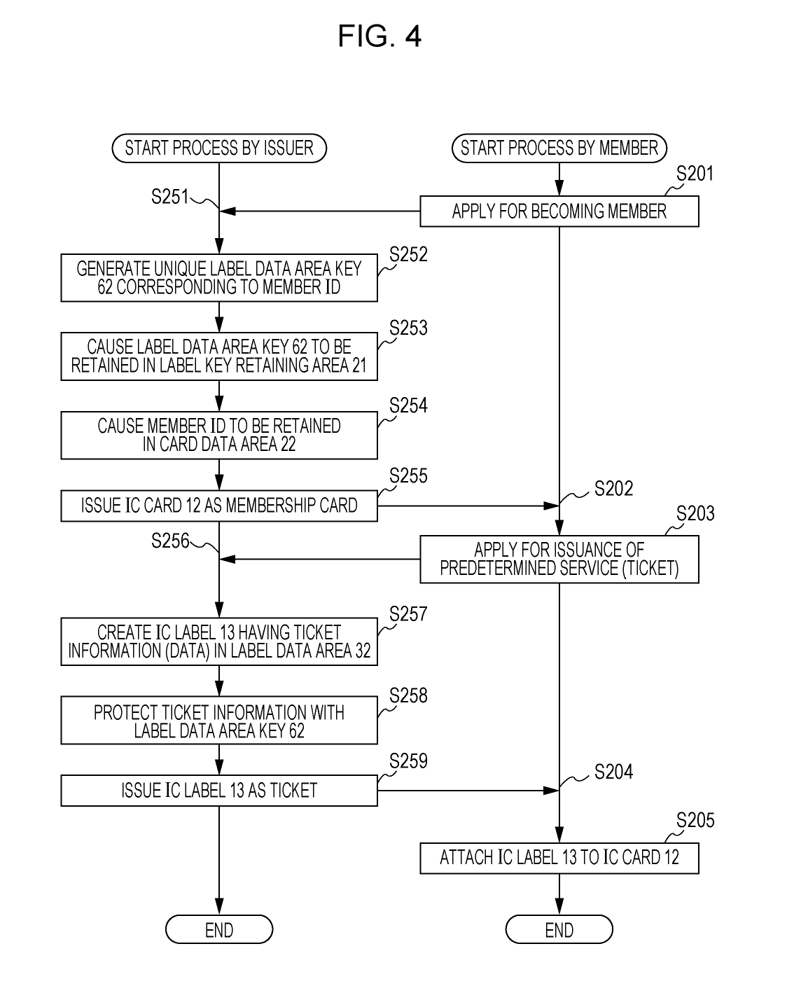

At step S110, the label data area processing section 108 and the card data area processing section 109 each perform an arbitrary service process. This arbitrary service process, which will be described further below with reference to FIG. 4, includes a process of writing data in and reading data from the card data area 22 of the IC card 12 and a process of writing data in and reading data from the label data area 32 of the IC label 13.

In this manner, when the IC label 13 is affixed to the IC card 12, data can be written in the IC card 12 and data can be read from and written in the IC label 13. Thus, a service using such data reading and writing is provided.

On the other hand, when it is determined at step S104 that the IC label 13 has not been captured or when it is determined at step S107 that authentication of the IC label 13 has not been successful (failed), the procedure goes to step S111. Such a situation occurs when the IC label 13 is not affixed to the IC card 12 or when the pair of the IC card 12 and the IC label 13 is wrong.

At step S111, the IC card authenticating section 101 reads the card data area key 52 retained in the card data area key retaining section 104, and performs authentication of the IC card 12. That is, assuming that the IC label 13 is affixed to the IC card 12, the reader/writer 11 performs authentication by using the label key retaining area key 51 for eventually accessing the IC label 13. However, if such authentication fails, the reader/writer 11 again performs authentication of the IC card 12 with the card data area key 52 for use when the IC label 13 is not affixed.

With authentication at step S112, the card data area 22 of the IC card 12 becomes accessible. Then, data is read from the accessible card data area 22 at step S113, and thus an arbitrary service process is performed.

In this case, since the card data area 22 is authenticated with the read-only card data area key 52, data can be read from the card data area 22, but data is not allowed to be written. This prevents the data written in the IC card 12 from being rewritten when the IC label 13 is not affixed, meaning that the data written in the IC card 12 can be protected.

With the process as described above being performed in the reader/writer 11, a process of writing data in the IC card 12 and the IC label 13 can be performed, and therefore a predetermined service can be provided. Also, depending on whether the IC label 13 is affixed to the IC card 12, a different service can be provided.

### Application to Member Services

Next, an exemplary embodiment achieved by using the IC card 12 having the IC label 13 described above affixed thereto is described by using specific examples. First, an example is described with reference to a flowchart of FIG. 4, in which a user becomes a member of a shop that provides a predetermined service, the IC card 12 is used as a membership card of that shop, and the IC label 13 is used as a ticket issued for receiving the predetermined service.

In FIG. 4, a side including the reader/writer 11, providing a service, and issuing a membership card is referred to as an issuer, and a side receiving the membership card is referred to as a member. The process to be performed between the issuer and the member is described by also referring to the process to be performed at the reader/writer 11, the IC card 12, and the IC label 13.

At step S201, the member applies to the issuer for becoming a member. When receiving an application from the member at step S251, the issuer generates the label data area key 62 unique to a member ID at step S252. The member ID is an identifier assigned to each member for identification. The label data area key 62 corresponding to this member ID can be used as the label data area key 62 assigned to each member.

At step S253, the label data area key 62 is retained in the label key retaining area 21. For example, the generated label data area key 62 is written by the reader/writer 11 in the label key retaining area 21 of the IC card 12. When the label data area key 62 is written by the reader/writer 11 in the IC card 12, the reader/writer 11 also retains a key for writing not shown in FIG. 1. By using the key for writing, key writing in the IC card 12 is performed.

The label data area key 62 itself may be generated by the reader/writer 11 based on, for example, a predetermined algorithm from the member ID. Alternatively, the label data area key 62 tied in advance to the member ID may be managed and the managed key may be read. To record the label data area key 62 and others, the issuer owns in advance a vacant IC card 12 and IC label 13 having no keys and data recorded thereon.

At step S254, the member ID is retained in the card data area 22. In this manner, the IC card 12 having the label data area key 62 and the member ID written therein is issued to the member as a membership card at step S255. The member receives the issued IC card 12 as a membership card from the issuer at step S202.

The member receiving the IC card 12 as a membership card in the manner as described above makes a request at step S203 to the issuer for providing a predetermined service. Provision of a predetermined service may include issuance of a ticket and issuance of coupons. Examples of the ticket include a ticket for receiving a predetermined service, a concert ticket, and a ticket for entrance to an amusement park. Examples of the coupons include coupons for a vehicle, such as a train or bus. Here, it is assumed for convenience of description that a ticket is to be issued.

When receiving a request from the member at step S256, the issuer writes ticket information (data) in the label data area 32 of the vacant IC label 13 having no data recorded thereon, thereby creating the IC label 13 with the ticket information written therein at step S257. This process can also be performed by the reader/writer 11 writing data in the IC label 13.

When it is assumed that data, here as depicted in FIG. 1, the data 72, is written in the label data area 32, the data 72 is protected with the label data area key 62 at step S258. As the label data area key 62, the label data area key 62 retained in the label key retaining area 21 of the IC card 12 is used.

The IC label 13 in which data is written in the label data area 23 and which is protected with the label data area key 62 in the manner as described above is issued as a ticket to the member at step S259. The member receiving thus issued IC label 13 at step S204 affixes the IC label 13 to his or her IC card 12 at step S205. Note that when the process as described above is performed on an issuer side, the process on the issuer side may be performed with the IC label 13 affixed to the IC card 12.

When the IC label 13 is affixed to the IC card 12 in the manner as described above, the process described with reference to the flowchart of FIG. 3 can be performed. For example, the member goes to a predetermined venue by carrying the ticket, and holds the IC card 12 with the IC label 13 affixed thereto over the reader/writer 11 placed in that venue. When the held combination of the IC card 12 and the IC label 13 is correct, the ticket information written in the label data area 32 of the IC label 13 is read. Therefore, the IC label 13 can function as a ticket.

Also, in order to prevent thus used ticket from being used again, a process of writing data indicating that the ticket has been used in the label data area 32 or deleting the data 72 is performed on the IC label 13 when the IC card 12 is held over. With this process, the IC label 13 can be prevented as being used again as a ticket. Furthermore, since the member can peel off the used and unwanted IC label 13 from the IC card 12, the IC card 12 itself can be reused as a membership card.

Still further, when the IC label 13 represents coupons, every time one of the coupons is used, the fact of use is written in the label data area 32. Then, the IC label 13 can be used as coupons until the number of times written becomes a predetermined number of times. Since such usage is possible according to the IC card 12 having the IC label 13 affixed thereto, the IC label 13 can be used as coupons.

In this manner, services, such as tickets and coupons, can be achieved on the IC card 12 by being combined with the IC label 13.

### Embodiment as a Contract

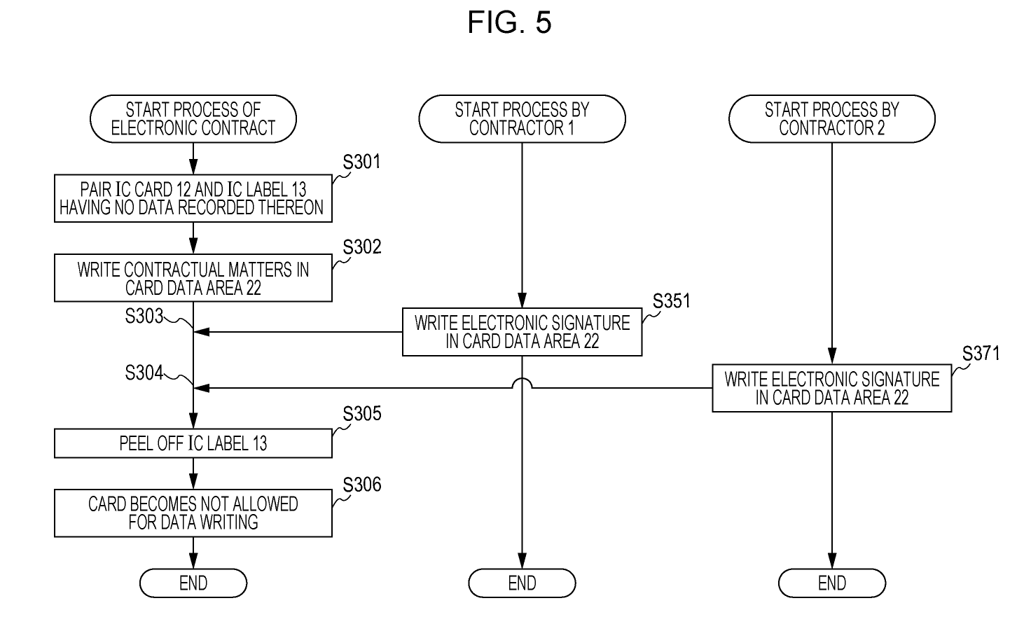

Next, as another embodiment, a case is described with reference to a flowchart of FIG. 5 in which the IC card 12 is used as a contract. By utilizing a feature that data is not allowed to be written to the IC card 12 only when the IC label 13 is affixed, the IC card 12 is used as an electronic contract, in which contractual matters and information about contractors are written.

At step S301, a pair of the IC card 12 and the IC label 13 having no data recorded thereon is prepared. The paired IC card 12 and IC label 13 are in a state in which keys as depicted in FIG. 1 are stored. To the IC card 12, the IC label 13 is affixed.

At step S302, contractual matters are written in the card data area 22 of the IC card 12. This process is performed in the course of performing the processes of the flowchart depicted in FIG. 3 as an arbitrary service process at step S110. That is, up to the processes before step S110, authentication between the reader/writer 11 and the IC card 12 and authentication between the reader/writer 11 and the IC label 13 have been normally performed. Therefore, since the card data area 22 can be accessed, and access can be performed with the card data area key 71, data can be written in the accessible card data area 22.

In this state, data about the contractual matters is written in the card data area 22 of the IC card 12 through a non-contact communication from the reader/writer 11. Here, description is made to an exemplary case in which two persons are involved in a contract, one being referred to as a contractor 1 and the other being referred to as a contractor 2.

At step S351, the contractor 1 performs a process for writing his or her own electronic signature in the card data area 22 of the IC card 12. The reader/writer 11 subjected to this process at step S303 writes the electronic signature of the contractor 1 in the card data area 22 of the IC card 12 based on that process. Similarly, when the contractor 2 performs a process for writing his or her own electronic signature in the card data area 22 of the IC card at step S371, the reader/writer 11 writes the electronic signature of the contractor 2 in the card data area 22 of the IC card 12 at step S304.

When the contractual matters and the electronic signatures of the contractors are written in the card data area 22 in the manner as described above, the IC label 13 is peeled off from the IC card 12 at step S305. This peel-off is performed only when all of the contractors, that is, both of the contractor 1 and the contractor 2 in this case, have agreed to the contractual matters. With the IC label 13 peeled off, the IC card 12 becomes not allowed for data writing at step S306.

The IC label 13 is preferably discarded after peeled off. This is to prevent the contractual matters from being tampered with the IC label 13 being again affixed to the IC card 12.

The contractual matters and others written in the card data area 22 in the manner as described above can be viewed by performing authentication by the reader/writer 11 using the card data area key 52 when the IC card 12 is held over the reader/writer 11.

That is, at step S104 of the flowchart of FIG. 3, it is determined that the IC label 13 has not been captured, and the procedure goes to step S111. Therefore, authentication by the reader/writer 11 using the card data area key 52 is performed, and only reading of data in the card data area 22 is allowed. Also, in this case, the arbitrary service at step S113 is viewing the contractual matters.

In this manner, the IC card 12 can be used as an electronic contract. Also, with such as simple process as removal or peel-off of the IC label 13, data is allowed to be written in the IC card 12, thereby preventing the written data from being tampered.

Embodiment when a Plurality of IC Labels are Affixed

In the embodiments described above, description is made to a case in which one IC card 12 and one IC label 13 are used in a pair. Next, an embodiment when a plurality of IC labels are affixed to one IC card is described. When a plurality of IC labels are affixed to one IC card, different services can be provided based on the respective IC labels.

Note that, for convenience of description, a case is exemplarily described below in which two IC labels are affixed to one IC card, but an embodiment of the present invention can be applied to even a case in which two or more IC labels are to be affixed. Also, even when two or more IC labels are affixed, the basic process can be performed in a manner similar to that of the case described below, in which two IC labels are affixed.

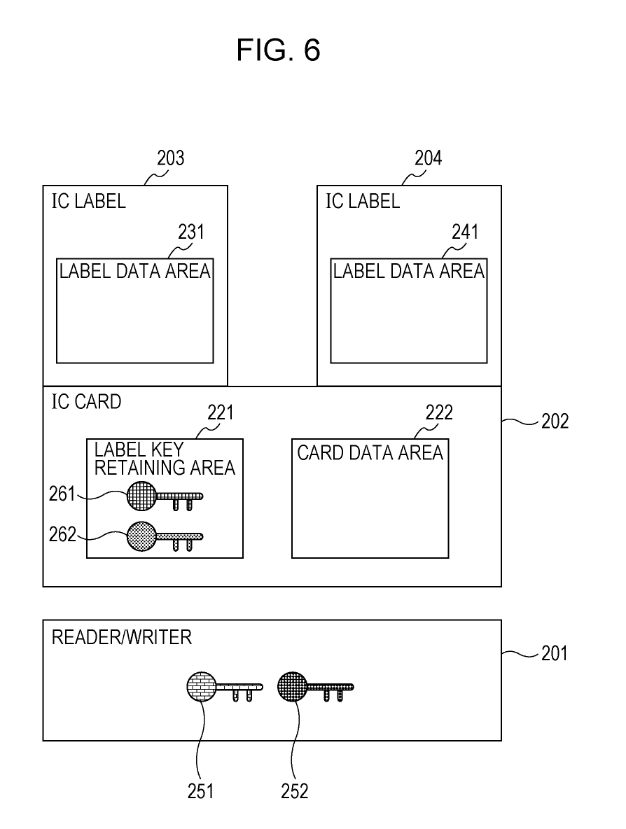

FIG. 6 depicts an example of structure of a system when a plurality of IC labels are affixed. The system depicted in FIG. 6 includes a reader/writer 201, an IC card 202, an IC label 203, and an IC label 204.

The IC card 202 includes a label key retaining area 221 and a card data area 222. The label key retaining area 221 retains keys in accessing data storage areas of the IC label 203 and the IC label 204. The card data area 222 is a data storage area of the IC card 202.

The IC label 203 includes a label data area 231. The label data area 231 is a data storage area of the IC label 203. Similarly, the IC label 204 includes a label data area 241, and the label data area 241 is a data storage area of the IC label 204.

The label key retaining area 221 of the IC card 202 retains a label data area key 261 for accessing the label data area 231 of the IC label 203 and a label data area key 262 for accessing the label data area 241 of the IC label 204.

The reader/writer 201 retains a label key retaining area key 251 for accessing the label key retaining area 221 of the IC card 202 and a card data area key 252 for accessing the card data area 222 of the IC card 202.

The label key retaining area key 251 and the card data area key 252 retained in the reader/writer 201 are keys common to services. The label key retaining area key 251 is a read-only key, is used for reading keys retained in the label key retaining area 221 of the IC card 202, and is not used for writing.

The card data area key 252 retained in the reader/writer 201 is a read-write key, and is used for reading data from the card data area 222 of the IC card 202 and writing data in the card data area 222.

The label data area key 261 and the label data area key 262 are keys unique to the label, and are read-write keys. The label data area key 261 is a key for use in reading data from the label data area 231 of the IC label 203 and writing data in the label data area 231. The label data area key 262 is a key for use in reading data from the label data area 241 of the IC label 204 and writing data in the label data area 241.

Basically, the process of the reader/writer 201 in the above-structured system is performed in a manner similar to that of the process in the flowchart depicted in FIG. 3, that is, the process by the reader/writer 11 depicted in FIG. 1, and therefore is not described herein.

Consider a case in which the above-structure IC card 202 and IC label 203 are used in, for example, a shopping mall in which a plurality of shops gather. When the shopping mall includes ten shops, for example, the IC card 202 can be used as a loyalty card commonly usable in these ten shops. Among these ten shops, the IC label 203 can be used as a loyalty card of a shop A, and the IC label 204 can be used as a loyalty card of a shop B.

In this case, in the card data area 222 of the IC card 202, information common to the ten shops in the shopping mall is written. Information about the shop A is written in the label data area 231 of the IC label 203, and information about the shop B is written in the label data area 241 of the IC label 204. Since the IC label 203 and the IC label 204 are affixed to the IC card 202, they are just like one card and can function as a plurality of point cards usable in the shopping mall and usable at predetermined shops in the shopping mall.

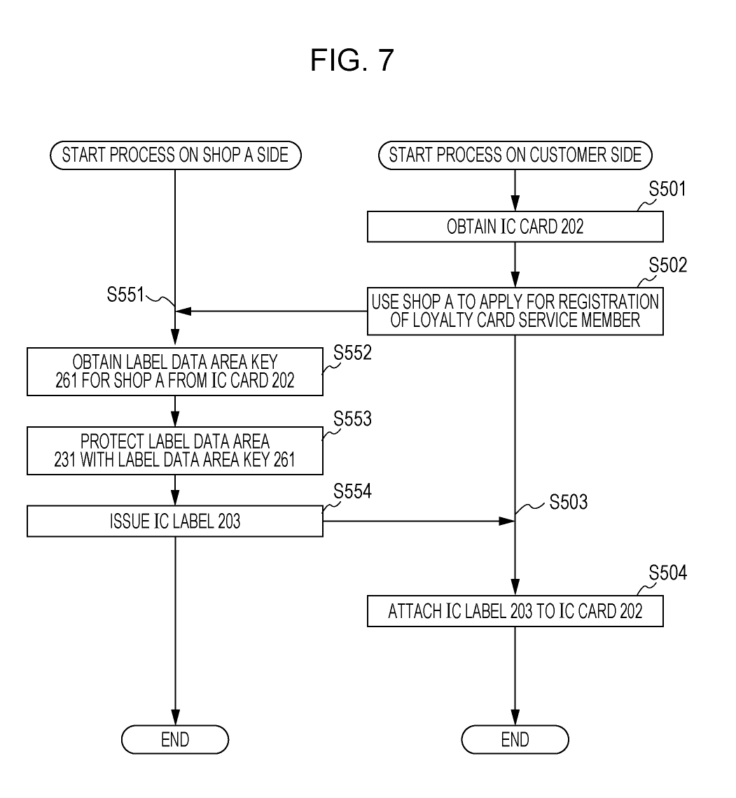

The process to be performed on a shop A side and the process to be performed on a customer side when the IC card 202 and the IC label 203 (the IC label 204) are used as a loyalty card are described with reference to a flowchart of FIG. 7. It is assumed for convenience of description that the IC label issued by the shop A is the IC label 203.

At step S501, a customer obtains the IC card 202. In the label key retaining area 221 of the IC card 202, label data area keys of IC labels that can be issued by the respective shops in the shopping mall are retained in advance. For example, when there are ten shops and each of the ten shops provides its own service, such as a loyalty card service, ten label data area keys corresponding to the respective shops are stored.

The customer obtaining the IC card 12 having the plurality of these keys stored therein uses the shop A at step S502, and applies for member registration regarding a service (here, it is assumed to be a loyalty card service) provided uniquely by the shop A. The shop A receiving such an application at step S551 first takes the customer's IC card 202 temporarily at step S552.

Then, the label data area key 261 for the shop A retained in the label key retaining area 221 of that IC card 202 is read. When the label data area key 261 is read, the label data area 231 of the IC label 203 scheduled to be issued to the customer is protected at step S553 with the read label data area key 261. In this manner, the IC label 203 having the label data area 231 protected with the label data area key 261 for the shop A is issued to the customer at step S554.

Upon receiving the issued IC label 203 and the returned IC card 202 from the shop A at step S503, the customer affixes the IC label 203 to the IC card 202 at step S504.

In this manner, the customer obtains a loyalty card of the shop A as the IC label 203. Thereafter, the IC card 202 itself functions as a loyalty card usable in the shopping mall, and the combination of the IC card 202 and the IC label 203 functions as a loyalty card usable at the shop A in the shopping mall.

When the customer desires to receive services from shops different from the shop A, such as the shop B and a shop C, in the shopping mall, only by performing a process similar to that as described above, IC labels allowing the customer to receive the services at these shops can be obtained.

If the embodiments of the present invention are applied in the manner as described above, a plurality of loyalty cards can be achieved by one IC card 202 having a plurality of IC labels affixed thereto. Therefore, the customer can receive services from a plurality of shops even without carrying a plurality of loyalty cards.

If the embodiments of the present invention are applied in the manner as described above, a new service can be provided by affixing an IC label to an IC card. Also, in a service using an IC card, writing is performed with a dedicated reader/writer. However, by applying the embodiments of the present invention, a function can be provided and deleted only with a simple process of affixing and peeling-off of an IC label to and from the IC card. With this, provision and deletion of a privilege of writing onto the IC card and addition and deletion of data can be performed in a physical and visual way even under an environment without the presence of a reader/writer.

### Recording Medium

The series of processes described above can be executed by hardware and also by software. When the series of processes are executed by software, a program that configures the software is installed into a computer. Here, examples of the computer include a computer incorporated in dedicated hardware and a general-purpose personal computer capable of executing various functions when various programs are installed.

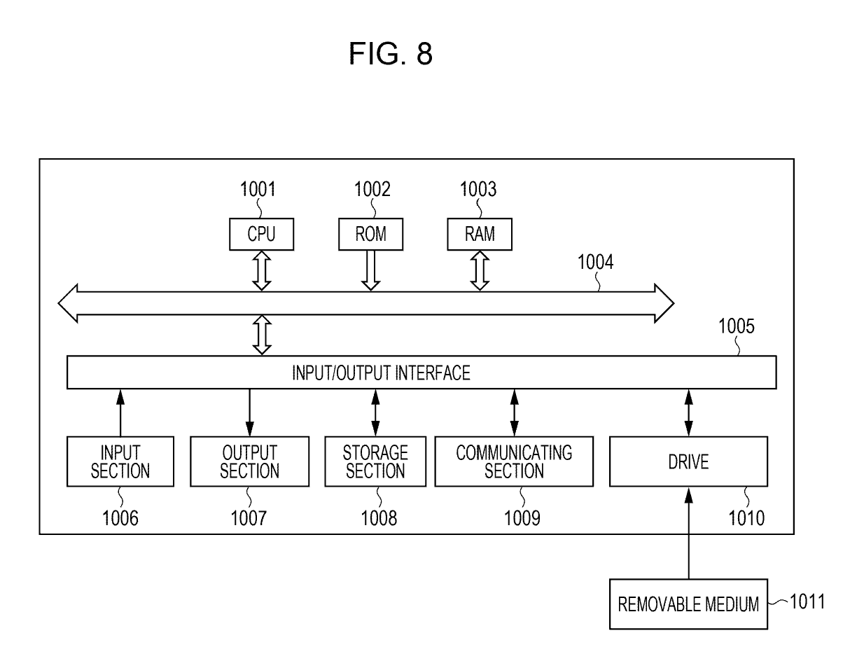

FIG. 8 is a block diagram of an example of structure of hardware of a computer that executes the series of processes described above with program. In the computer, a central processing unit (CPU) 1001, a read only memory (ROM) 1002, and a random access memory (RAM) 1003 are mutually connected to each other by a bus 1004. To the bus 1004, an input/output interface 1005 is further connected. To the input/output interface 1005, an input section 1006, an output section 1007, a storage section 1008, a communicating section 1009, and a drive 1010 are connected.

The input section 1006 is formed of a keyboard, a mouse, a microphone, and others. The output section 1007 is formed of a display, a loudspeaker, and others. The storage section 1008 is formed of a hard disk, a non-volatile memory, and others. The communicating section 1009 is formed of a network interface and others. The drive 1010 drives a removable medium 1011, such as a magnetic disk, an optical disk, a magneto-optical disk, or a semiconductor memory.

In the computer configured as above, the series of processes described above is performed by the CPU 1001 loading, for example, a program stored in the storage section 1008 via the input/output interface 1005 and the bus 1004 into the RAM 1003 for execution.

The program to be executed by the computer (the CPU 1001) can be provided, for example as being recorded on the removable medium as a package medium or the like. Also, the program can be provided via a wired or wireless transmission medium, such as a local area network, the Internet, or digital satellite broadcasting.

In the computer, the program can be installed in the storage section 1008 via the input/output interface 1005 by affixing the removable medium 1011 to the drive 1010. Also, the program can be received at the communicating section 1009 via a wired or wireless transmission medium and installed in the storage section 1008. In addition, the program can be installed in advance in the ROM 1002 or the storage section 1008.

Here, this program to be executed by the computer may be a program causing processes to be performed in time series according to the order described in this specification, a program causing processes to be performed in parallel, or a program causing processes to be performed at a timing, such as when a call is issued.

Also, in the specification, the system represents an entire apparatus configured of a plurality of apparatuses.

The present application contains subject matter related to that disclosed in Japanese Priority Patent Application JP 2010-117007 filed in the Japan Patent Office on May 21, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
key retaining means for retaining a key for use in writing data in a data storage area of another information processing apparatus or reading data stored in the data storage area; and
storage means for storing data; wherein the information processing apparatus is used by being combined with the other information processing apparatus,
the key retained in the key retaining means is protected with a key retained in the other information processing apparatus, and
the storage means is protected with the key retained in the other information processing apparatus.

2. The information processing apparatus according to claim 1, wherein
the other information processing apparatus is an IC card, and
the information processing apparatus is combined with the other information processing apparatus by being affixed to the IC card.

3. An information processing apparatus comprising:
storage means for storing data;
second key retaining means for retaining a second key for use by the information processing apparatus in writing data in the storage means or reading the data stored in the storage means, the second key for use in reading a first key retained in another information processing apparatus; and
third key retaining means for retaining a third key for use by the information processing apparatus in writing data in a data storage area of the other information processing apparatus or reading data stored in the data storage area.

4. The information processing apparatus according to claim 3, wherein
the information processing apparatus is an IC card, and
the information processing apparatus is used with the other information processing apparatus affixed thereto.

5. An information processing apparatus retaining a first key and a second key, the information processing apparatus comprising:
first storage means for storing first data;
retaining means for retaining a fourth key reading the first key and the second key from the information processing apparatus when another information processing apparatus retaining a third key and including second storage means for storing second data is combined;
first reading means for reading the first and second keys from the information processing apparatus with the fourth key;
second reading means for reading the third key retained in the other information processing apparatus with the first key read by the first reading means;
first processing means for accessing the first storage means included in the information processing apparatus by using the third key read by the second reading means and writing data in the first storage means or reading the first data stored in the first storage means; and
second processing means for accessing the second storage means included in the other information processing apparatus by using the second key read by the first reading means and writing data in the second storage means or reading the second data stored in the second storage means.

6. The information processing apparatus according to claim 5, wherein the information processing apparatus and the other information processing apparatus communicate with each other in a non-contact manner.

7. The information processing apparatus according to claim 5, wherein
the information processing apparatus is an IC card, and
the other information processing apparatus is affixed to the IC card.

8. The information processing apparatus according to claim 5, wherein the information processing apparatus retains a fifth key for use in accessing the first storage means of the information processing apparatus to read the data stored in the first storage means when the other information processing apparatus is not combined with the information processing apparatus.

9. An information processing method for an information processing apparatus retaining a first key and a second key and including first storage means for storing first data and at least retaining means for retaining a fourth key reading the first key and the second key from the information processing apparatus when the information processing apparatus is combined with another information processing apparatus retaining a third key and including second storage means for storing second data, the method comprising the steps of:
reading the first key and the second key from the information processing apparatus by using the fourth key;
reading the third key retained in the other information processing apparatus with the read first key;
accessing the first storage means included in the information processing apparatus by using the read third key, and writing data in the first storage means or reading the first data stored in the first storage means; and
accessing the second storage means included in the other information processing apparatus by using the read second key, and writing data in the second storage means or reading the second data stored in the second storage means.

10. A computer-readable program that causes an information processing apparatus retaining a first key and a second key and including first storage means for storing first data and at least retaining means for retaining a fourth key reading the first key and the second key from the information processing apparatus when the information processing apparatus is combined with another information processing apparatus retaining a third key and including second storage means for storing second data, to execute a process comprising the steps of:
reading the first key and the second key from the information processing apparatus by using the fourth key;
reading the third key retained in the other information processing apparatus with the read first key;
accessing the first storage means included in the information processing apparatus by using the read third key, and writing data in the first storage means or reading the first data stored in the first storage means; and
accessing the second storage means included in the other information processing apparatus by using the read second key, and writing data in the second storage means or reading the second data stored in the second storage means.

11. An information processing apparatus comprising:
storage means for storing data; wherein
the information processing apparatus is used in combination with another information processing apparatus, and
the storage means is protected with a key retained in the other information processing apparatus.

12. The information processing apparatus according to claim 11, wherein
the other information processing apparatus is an IC card, and
the information processing apparatus is combined with the other information processing apparatus by being affixed to the IC card.

13. An information processing apparatus comprising:
a data storage area that stores data;
key retaining means for retaining a key for use by another information processing apparatus in writing data in the data storage area or reading the data stored in the data storage area when the other information processing apparatus is combined with the information processing apparatus; and
storage means for storing data; wherein
the key retaining means retains a plurality of keys, and
the plurality of keys are each for accessing the data storage area included in each of a plurality of the information processing apparatuses.

14. The information processing apparatus according to claim 13, wherein
the information processing apparatus is an IC card, and
the information processing apparatus is combined by being affixed to the other information processing apparatus.

15. An information processing apparatus retaining a first key and comprising:
first storage means for storing first data;
retaining means for retaining a second key reading the first key from the information processing apparatus when another information processing apparatus including second storage means for storing second data is combined;
first reading means for reading the first key from the information processing apparatus by using the second key; and
processing means for accessing the second storage means included in the other information processing apparatus by using the first key read by the first reading means and writing data in the second storage means or reading the second data stored in the second storage means.

16. The information processing apparatus according to claim 15, wherein the information processing apparatus and the other information processing apparatus communicate with each other in a non-contact manner.

17. The information processing apparatus according to claim 15, wherein
the information processing apparatus is an IC card, and
the other information processing apparatus is affixed to the IC card.

18. The information processing apparatus according to claim 15, wherein the information processing apparatus further retains a third key for use in accessing the first storage means of the information processing apparatus and reading the data stored in the first storage means or writing data in the first storage means.

19. An information processing method for an information processing apparatus retaining a first key and including first storage means for storing first data and at least retaining means for retaining a second key reading the first key from the information processing apparatus when another information processing apparatus including second storage means storing second data is combined, the method comprising the steps of:
reading the first key from the information processing apparatus by using the second key; and
accessing the second storage means included in the other information processing apparatus by using the read first key and writing data in the second storage means or reading the second data stored in the second storage means.

20. A computer-readable program that causes an information processing apparatus retaining a first key and including first storage means for storing first data and at least retaining means for retaining a second key reading the first key from the information processing apparatus when another information processing apparatus including second storage means for storing second data is combined, to execute a process comprising the steps of:
reading the first key from the information processing apparatus by using the second key; and
accessing the second storage means included in the other information processing apparatus by using the read first key and writing data in the second storage means or reading the second data stored in the second storage means.

21. An information processing apparatus comprising:
a key retaining section retaining a key for use in writing data in a data storage area of another information processing apparatus or reading data stored in the data storage area; and
a storage section storing data; wherein
the information processing apparatus is used by being combined with the other information processing apparatus,
the key retained in the key retaining section is protected with a key retained in the other information processing apparatus, and
the storage section is protected with the key retained in the other information processing apparatus.

22. An information processing apparatus comprising:
a storage section storing data;
a second key retaining section retaining a second key for use by the information processing apparatus in writing data in the storage section or reading the data stored in the storage section, the second key for use in reading a first key retained in another information processing apparatus; and
a third key retaining section retaining a third key for use by the information processing apparatus in writing data in a data storage area of the other information processing apparatus or reading data stored in the data storage area.

23. An information processing apparatus retaining a first key and a second key, the information processing apparatus comprising:
a first storage section storing first data;
a retaining section retaining a fourth key reading the first key and the second key from the information processing apparatus when another information processing apparatus retaining a third key and including a second storage section storing second data is combined;
a first reading section reading the first and second keys from the information processing apparatus with the fourth key;
a second reading section reading the third key retained in the other information processing apparatus with the first key read by the first reading section;
a first processing section accessing the first storage section included in the information processing apparatus by using the third key read by the second reading section and writing data in the first storage section or reading the first data stored in the first storage section; and
a second processing section accessing the second storage section included in the other information processing apparatus by using the second key read by the first reading section and writing data in the second storage section or reading the second data stored in the second storage section.

24. An information processing apparatus comprising:
a storage section storing data, wherein
the information processing apparatus is used in combination with another information processing apparatus, and
the storage section is protected with a key retained in the other information processing apparatus.

25. An information processing apparatus comprising:
a data storage area that stores data;
a key retaining section retaining a key for use by another information processing apparatus in writing data in the data storage area or reading the data stored in the data storage area when the other information processing apparatus is combined with the information processing apparatus; and
a storage section stores data; wherein
the key retaining section retains a plurality of keys, and
the plurality of keys are each for accessing the data storage area included in each of a plurality of the information processing apparatuses.

26. An information processing apparatus retaining a first key and comprising:
a first storage section storing first data;
a retaining section retaining a second key reading the first key from the information processing apparatus when another information processing apparatus including a second storage section storing second data is combined;
a first reading section reading the first key from the information processing apparatus by using the second key; and
a processing section accessing the second storage section included in the other information processing apparatus by using the first key read by the first reading section and writing data in the second storage section or reading the second data stored in the second storage section.
